(19) United States
(12) Patent Application Publication
(10) Pub. No.: US 2023/0049875 A1
(43) Pub. Date: Feb. 16, 2023

(54) LIGHTBOX FOR DIGITAL PRESERVATION

(71) Applicant: HISTORYIT, INC., South Portland, ME (US)

(72) Inventors: Kristen GWINN-BECKER, Portland, ME (US); Donald LOWE, II, South Portland, ME (US)

(21) Appl. No.: 17/795,505

(22) PCT Filed: Jan. 28, 2021
(86) PCT No.: PCT/US2021/015589

§ 371 Date: Jul. 26, 2022

Related U.S. Application Data
(60) Provisional application No. 62/967,016, filed on Jan. 28, 2020.

(51) Int. Cl. G03B 15/03; G03B 17/56; H04N 5/225

(52) U.S. Cl. CPC G03B 15/03; G03B 17/561; H04N 5/2256; H04N 5/2252

(57) ABSTRACT

Described herein are lightboxes and methods of use for the digital preservation of historical collections. The lightbox includes abase, the base having a grid visible on at least one surface of the base, and a plurality of walls extending above and substantially perpendicular to the base. A support platform having an aperture therein is located within the plurality of walls and above the base and is secured in the lightbox via a height adjustment mechanism. A cover is positioned above the base and below the support platform and secured in the lightbox via one or more hinge mechanisms One or more lighting elements are positioned along one or more walls of the lightbox, each lighting element including at least one light.

### CROSS-REFERENCE TO RELATED APPLICATIONS

This application claims the benefit of U.S. Provisional Patent Application No. 62/967,016, filed Jan. 28, 2020, the disclosure of which is herein incorporated by reference.

### BACKGROUND

### 1. Field of the Invention

The present invention pertains to the field of historic preservation. Specifically, this invention relates to a novel lightbox and method of use that allows users to digitally preserve historical collections.

### 2. Discussion of Background Information

In order to democratize history and make it accessible, searchable and meaningful to all demographics, there must be a way to transform physical holdings into an accessible digital format. This involves two steps. The first is creating true digital preservation quality files that hold up over time as image and web technologies change. The second is cataloging and tagging every single item in a digital collection so that people can find them easily.

In the current state of the art, there are very few options on the market for the digital preservation of historical collections that are not cost prohibitive. Indeed, archivists seeking to digitize physical collections are hindered by the fact that archival-quality image capture requires specialized hardware, software, and expertise. All of these elements are difficult or costly to acquire—both for professional archivists and non-professional archive custodians (e.g., family historians).

In order to minimize the need for cost prohibitive equipment and expertise, an archivist may attempt to use currently available options such as a scanner or a lightbox combined with a typical capture device, such as a mobile phone. However, without specialized hardware, software and expertise, users experience common digitization problems, including problems with lighting, object orientation, camera manipulation, and capture device placement. Further complicating matters is that typical capture device cameras are associated with image quality shortcomings such as noise, limited dynamic range, and loss of fine detail. In order to overcome these shortcomings, capture devices utilize image processing, such as over-sharpening, noise reduction, over-saturation and HDR, for each image captured. However, true digital preservation should create the truest possible representation of the item. Indeed, the image processing employed by capture device cameras fails to provide images with the resolution, color and luminance that reflect the original captured item as closely as possible.

In addition, currently available digital archiving options can be inefficient and time consuming. These current options are limited by the time it takes for the device to actually scan or photograph the item, the time it takes for the user to place and orient the item in the device, and the user's knowledge of settings such as color, resolution, bit depth and file formats. For example, while some higher-end desktop scanners can avoid the common digitization problems discussed above and reach the resolutions of true digital preservation, most take two minutes or more to scan a single item. Such a time-consuming process limits the volume an archivist will be able to digitize at any given time. Given that historic preservation is often done by volunteers who are donating their time and effort, time consumption and efficiency are important and necessary considerations. In addition, scanners suffer from similar shortcomings as capture devices and may automatically try to compensate for the condition of the item by boosting colors and brightness. Again, true digital preservation should create the truest possible representation of the item without image processing.

U.S. Pat. Nos. 6,672,737 and 6,814,468 to Lai et al. disclose examples of existing lightboxes. The Lai devices are lamp boxes using a lighting source, constructed to include a housing, the housing having a top opening for the mounting of a camera for taking photos of a real object and a door at one side. Notably, the Lai devices fail to provide an adjustable support platform for accommodating different sized objects. Instead the mounting for the camera is fixed at the top of the housing.

U.S. Pat. No. 7,055,976 to Blanford discloses another example of an existing lightbox. The Blanford device is a collapsible tabletop lighting apparatus consisting of a box-like structure for photographing 3D subjects in an evenly illuminated environment. The Blanford device is designed such that a 3D subject is placed on the floor in the box-like structure and illuminated by the lighting unit. The lighting unit contains a fluorescent circular tube and a light diffuser panel. In addition, the interior of the box-like structure is coated so to efficiently reflect the light from the fluorescent tube back on to the 3D subject being photographed. Similar to the Lai devices, the Blanford device fails to provide an adjustable support platform for accommodating different sized objects. Indeed, the Blanford device does not even provide any mounting for a camera because the 3D subject is placed on the floor in the box-like structure while a digital camera is held outside and pointed toward the interior and the subject.

U.S. Patent Application US 2011/0228538 to Yu et al. discloses yet another example of an existing lightbox. The Yu device is a document camera and a light box with a base, light guiding plate embedded in the base, and a light source device movably disposed on the base. Notably, the Yu device is not a box-like structure and, therefore, does not have walls. Without walls, the Yu device would be incapable of creating the environment necessary to digitize historical collections. In addition, the Yu device fails to provide any mounting or resting place for a camera. Instead, the camera disclosed in Yu is incorporated into the device itself.

While other devices and methods have been proposed for digitizing historical collections, none of these inventions, taken either singly or in combination, adequately address or resolve the aforementioned problems. Therefore, a need exists for a device and method for digitally preserving historical collections.

### SUMMARY OF THE INVENTION

The present invention solves the problems associated with digitizing historical collections, including lighting, object orientation, camera manipulation, and capture device placement, and provides a device and method for efficiently and accurately capturing items and uploading newly created digital archival master files to a software platform for asset management and metadata creation (cataloging and tagging).

The present invention is directed to a lightbox for the digital preservation of historical collections. The lightbox comprises a base, the base having a grid visible on at least one surface of the base; a plurality of walls, wherein the plurality of walls extend above and substantially perpendicular to the base; a support platform having an aperture therein, the support platform located within the plurality of walls and above the base, and secured in the lightbox via a height adjustment mechanism; a cover positioned above the base and below the support platform and secured in the lightbox via one or more hinge mechanisms; and one or more lighting elements positioned along one or more walls of the lightbox, each lighting element including at least one light. In addition

The present invention is also directed to a method of using a lightbox for the digital preservation of historical collections. The method comprises a first step of providing a lightbox for the digital preservation of historical collections, the lightbox comprising a base, the base having a grid visible on at least one surface of the base; a plurality of walls, wherein the plurality of walls extend above and substantially perpendicular to the base; a support platform having an aperture therein, the support platform located within the plurality of walls and above the base, and secured in the lightbox via a height adjustment mechanism; a cover positioned above the base and below the support platform and secured in the lightbox via one or more hinge mechanisms; and one or more lighting elements positioned along one or more walls of the lightbox, each lighting element including at least one light. A second step includes providing an image capture device, the image capture device including a camera and having image capture software installed thereon, while a third step includes launching the image capture software installed on the capture device. A fourth step involves activating the one or more lighting elements, which turns on the at least one light of each lighting element. A fifth step comprises positioning the capture device on the support platform such that the image capture device camera is aligned with the aperture in the support platform and directed at the base, and a sixth step includes adjusting the support platform to the desired height and securing the support platform using the height adjustment mechanism. A seventh step includes lifting the cover and placing an item on the base in alignment with the grid and closing the cover over the item. An eighth step comprises providing a light reflector and positioning the light reflector within the one or more slots in the cover of the lightbox. A ninth step includes capturing the item by activating a capture functionality in the software installed on the capture device and causing the image capture device to capture multiple images of the item, and a tenth step comprises passing the multiple captured images into a process queue, where the multiple captured images are merged into a single, high-resolution capture image. An eleventh step includes passing the single, high-resolution capture image to an upload queue, where the single, high-resolution capture image is uploaded to a software account over a network connection such as WiFi or cellular for asset management, derivative creation and metadata creation. In addition, where the capture device further includes software that provides a visual grid, visible on a display of the capture device, the method may include either or both of the optional steps of aligning the visual grid with the grid on the base and aligning the visual grid with the edge of the item to ensure the correct orientation once the cover is closed.

### BRIEF DESCRIPTION OF THE DRAWINGS

These and other features, aspects and advantages of the present invention will become better understood with reference to the following description, appended claims, and accompanying drawings where:

FIG. 1 is a front perspective view of an embodiment of a lightbox of the present invention.

FIG. 2 is a top front perspective view of an embodiment of a lightbox of the present invention.

FIG. 3 is a top front perspective view of an embodiment of a lightbox of the present invention.

FIG. 4 is a front perspective view of an embodiment of a lightbox of the present invention.

FIG. 5 is an enlarged front perspective view of an embodiment of a lightbox of the present invention.

FIG. 6 is an enlarged front perspective view of an embodiment of a lightbox of the present invention.

FIG. 7 is a front cross-section view of an embodiment of a lightbox of the present invention.

FIG. 8 shows the steps of one method of the present invention.

### DETAILED DESCRIPTION OF THE INVENTION

The present invention is directed to the problems associated with digitizing historical collections and provides a system, method and device for accurately and efficiently capturing items and uploading newly created digital archival master files to a software platform for asset management and metadata creation.

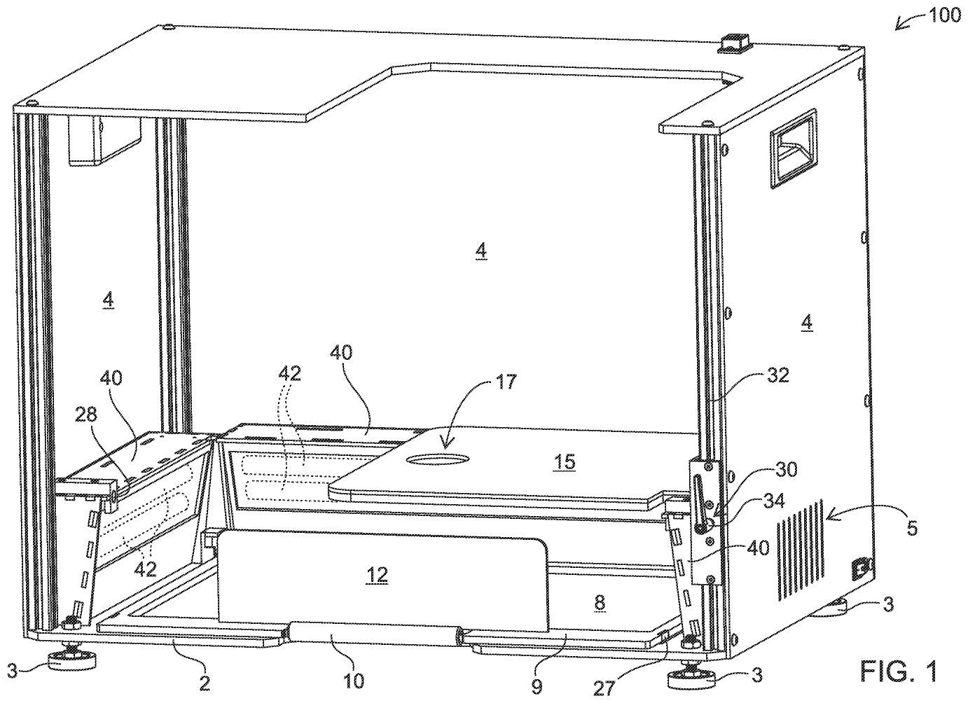

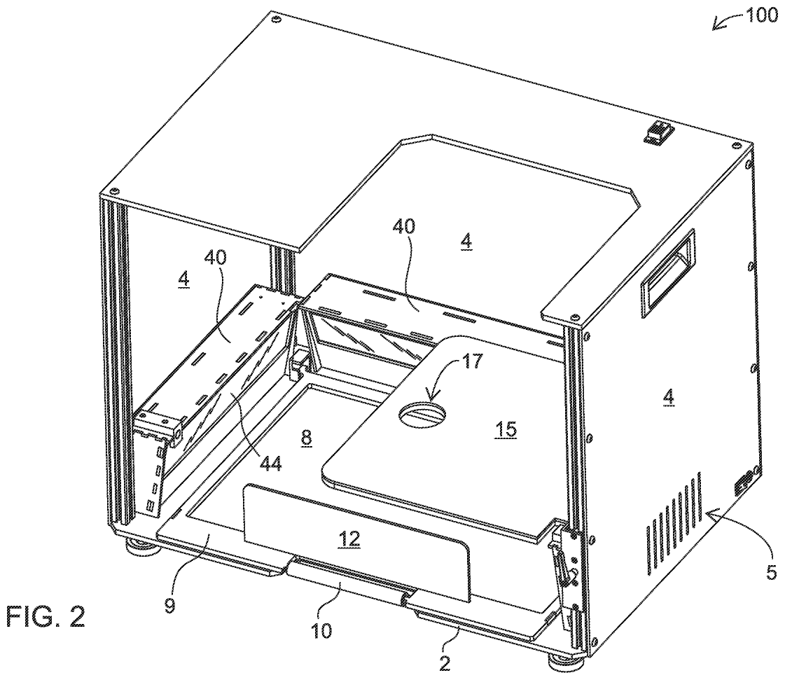

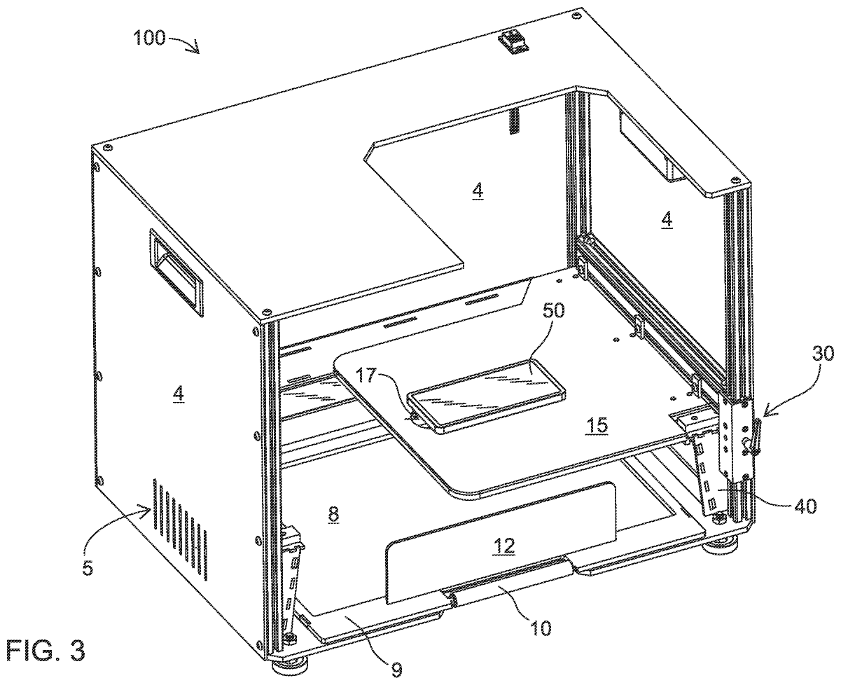

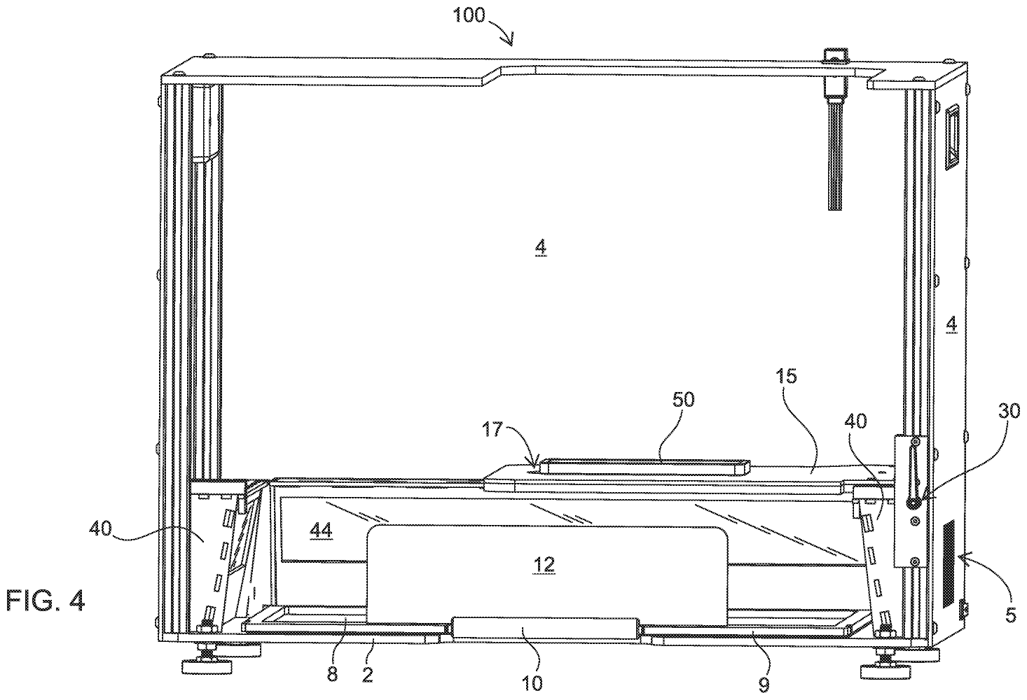

The lightbox of the present invention is a device directed to the digital preservation of historical collections. Turning to FIGS. 1-4, the lightbox 100 has a base 2 and a plurality of walls 4 extending above and substantially perpendicular to the base 2. In exemplary embodiments, the base 2 is rectangular and there is a wall 4 positioned on three sides of the base 2 such that the three walls 4 would be positioned on the two short sides and one long side of the rectangular base 2, leaving one long side of the base 2 without a wall. The base 2 may be any non-reflective material known in the art. However, in exemplary embodiments, the base 2 may be a non-reflective gray acrylic baseboard. In addition, the base 2 may include grid guide visible on at least one surface of the base 2 to ensure the correct orientation of items being digitized. In some embodiments, the grid guide is etched into the base 2.

On the exterior of the lightbox 100, the lightbox 100 may include a plurality of feet 3. The plurality of feet 3 may extend from the base 2 or may be attached to the walls 4. In some embodiments, the plurality of feet 3 are adjustable such that the lightbox 100 can be leveled if it is resting on an unlevel surface. In other embodiments, the plurality of feet 3 may be a plurality of legs, which support the lightbox 100 and allow it to operate as a freestanding device. Where the plurality of feet 3 are a plurality of legs, the plurality of legs may be adjustable to enable leveling of the lightbox 100 and adjustment of the lightbox 100 height.

Located within the walls 4 and above the base 2 is a support platform 15 that suspends or supports a capture device 50. The support platform 15 may include an aperture 17 such that a camera on the capture device 50 can be positioned in the aperture 17 with the camera lens directed toward the base. In some embodiments, the support platform 15 may include one or both of a capture device 50 guide to ensure that the capture device 50 is properly aligned on the support platform 15 and a non-slip material to prevent any movement of the capture device 50.

The support platform 15 is secured in the lightbox 100 in a manner that utilizes a height adjustment mechanism 30 to move the support platform 15 higher or lower in relation to the base 2. In some embodiments, the height adjustment mechanism 30 may include one or more vertical bars 32 and a friction device 34 such as a thumb screw, twist secure or other similar feature as known in the art to hold the support platform 15 at the desired height. In operation, the support platform 15 may be adjusted along the length of the vertical bar 32 and then secured at the desired height via the friction device 34. As will be readily understood by a person of skill in the art, the distance between the support platform 15 and the base 2 will be adjusted to account for the focal length of the camera lens present on the capture device 50 and the size of the item being captured. For example, based on the same capture device 50, capturing a larger item will require raising the support platform 15 farther from the base 2 than capturing a smaller item. In some embodiments, there may be preset heights for the support platform 15. These preset heights may include stops to accommodate users with decreased motor skills. Further, in some embodiments, the height of the support platform 15 may correspond with specific gridlines of the grid guide.

The lightbox 100 further includes a cover 8, positioned above the base 2. The cover 8 is substantially transparent, prevents glare and compresses the item being captured to ensure the highest quality capture image. The cover 8 may be comprised of anti-glare material or may incorporate anti-glare coatings as known in the art. For example, the cover 8 may be comprised of a glass such as museum glass or the cover 8 may be comprised of a plastic such as museum acrylic. The cover 8 is hinged at the back of the lightbox 100 such that it can be raised at a front edge. In some embodiments, the front edge is the edge of the cover 8 adjacent to the open side of the base 2, i.e., the side of the base 2 without a wall 4. Once raised, an item can be inserted underneath the cover 8. In some embodiments, the cover 8 may include a cover frame 9.

The cover 8 may further include a handle 10 to allow the user to raise and lower the cover 8. In some embodiments, the handle 10 may be positioned along the front edge of the cover 8. The cover 8 may also include magnets 27 positioned along the edge of the cover 8, the magnets 27 configured to engage in magnetic contact with additional magnets 28 positioned above the base 2 such that once magnetically engaged, the magnets 27, 28 hold the cover 8 open while a user inserts or removes an item. In some embodiments, magnetic material can be substituted for either the magnets 27 or the additional magnets 28 to create the magnetic contact necessary to hold the cover 8 in the open position. Where the cover 8 includes a frame 9, the handle 10 and magnets 27 may be located in the frame 9.

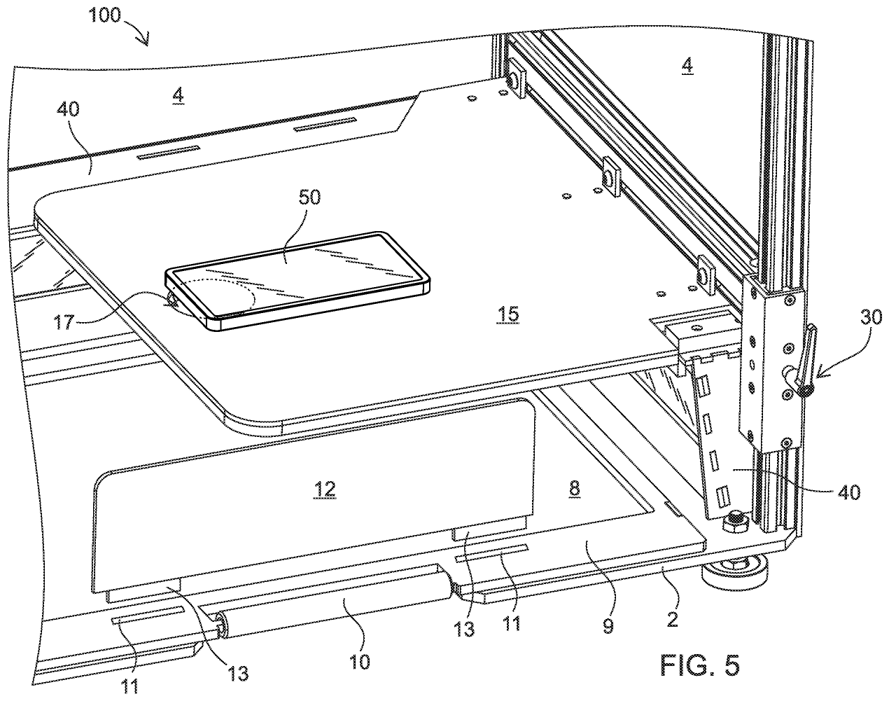

Turning to FIG. 5, in embodiments where the lightbox 100 includes an open side, the lightbox 100 may include a removable light reflector 12. The removable light reflector 12 is an insert that includes one or more tabs 13 and is removably secured to the cover 8 by inserting the one or more tabs 13 into one or more slots 11 located near the front edge of the cover 8. Where the light reflector 12 is an insert that is removably secured to the cover 8, the light reflector 12 is preferably shorter than the distance between the two side walls 4 of the lightbox 100 to ensure that the light reflector 12 does not prevent the raising of the cover 8 during operation. The light reflector 12 may be made of any material. However, in exemplary embodiments, the insert is a white acrylic.

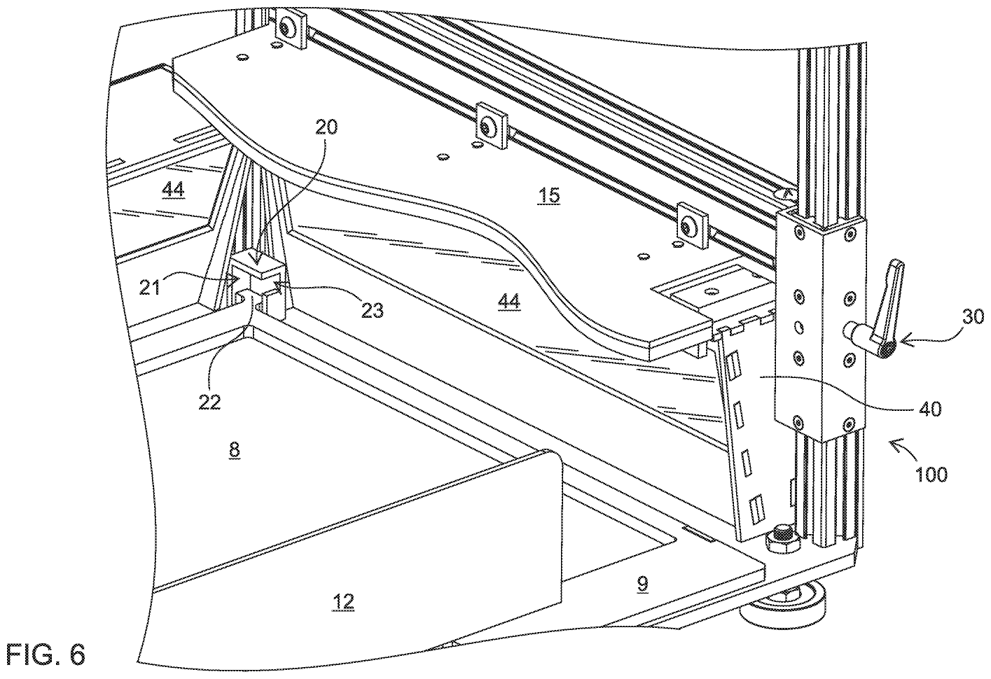

Turning to FIG. 6, the cover 8 is hinged via one or more hinged mechanisms 20. The hinge mechanisms 20 may be floating hinge mechanisms 20, wherein a slot 21 is provided in each hinge mechanism 20 to allow the rear edge of the cover 8 to raise a predetermined distance above the base 2 while remaining engaged in the hinge mechanism 20. In such embodiments, the cover 8 has one or more protrusions 22 along the rear edge that are inserted into the slot 21 and move freely up and down within the slot 21 to allow the cover 8 to adjust to the height of each item being archived. For example, where a simple sheet of paper such as a letter is being archived, the rear edge of the cover 8 secured by the floating hinge mechanism 20 will barely raise above the base 2 at all, allowing the cover 8 to fully contact the thin paper. In contrast, where thicker items such as a book are being archived, the rear edge of the cover 8 secured by the floating hinge mechanism 20 will raise to accommodate the thickness of the book and the cover 8 will then sit flush across the top of the book. Whether the hinge mechanism 20 is a simple hinge as known in the art or a floating hinge mechanism 20 as described herein, the hinge mechanism 20 may also include a notch 23 so that the cover 8 can be removed entirely. For example, in embodiments with a floating hinge mechanism 20, the notch 23 may be positioned at the top of the slot 21. In order to remove the cover 8, the rear edge of the cover 8 is raised by sliding the one or more protrusions 22 to the top of the slot 21 and then the one or more protrusions 22 are pulled out through the notch 23 to remove the cover 8. Where the cover 8 includes a frame 9, the protrusions may be part of and extend from the frame 9 for engagement with the hinged mechanism 20.

The lightbox 100 includes one or more lighting elements 40 positioned along one or more walls 4 of the lightbox 100 and oriented to focus the light toward the base 2. The lighting elements 40 comprise one or more lights 42 mounted within the lighting element 40. The lights 42 may be LEDs connected to one or more bars 43 located within the lighting element 40. Alternatively, the lights 42 may be incandescent, fluorescent, compact fluorescent, or halogen lights. The lighting elements 40 may further comprise a transparent or semitransparent lens 44. The lens 44 protects the lights 42 and in some embodiments, the lens 44 alters the direction of the light emitted from the lights 42. For example, the lens 44 is a Fresnel lens in some embodiments. In exemplary embodiments, the lightbox 100 has three lighting elements 40, wherein a lighting element 40 is positioned horizontally along each of the three walls 4 at a height and with the lens positioned at an angle to ensure that the base 2 receives even lighting. In some embodiments, the one or more lighting elements 40 are each positioned approximately two inches above the base 2 and the lens 44 of each lighting element 40 is positioned at an angle of approximately 25 degrees relative to the wall.

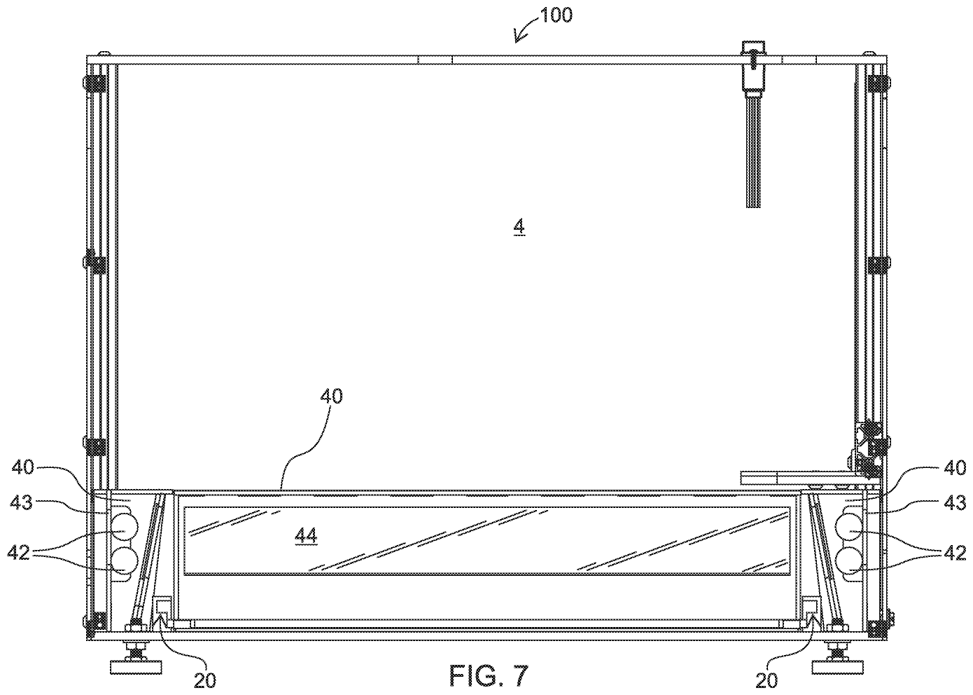

The lights 42 may be mounted to a heat sink in order to transfer the heat generated by the one or more lighting elements 40. For example, as best shown in FIG. 7, the lights 42 may be mounted to one or more bars 43, where the bars 43 function as a heat sink. In such embodiments, the bar 43 may be an aluminum bar. In order to disperse the heat from the heat sink to the air, the portion of the wall 4 behind the heat sink may be slotted to facilitate cooling.

The capture device 50 includes software to digitally capture and transmit archival quality digital images. The capture device 50 may be any phone or tablet with a camera. As used herein, references to the location and position of the camera refers to the location and position of the camera lens. The image capture software is installed on the capture device 50 as an application, which, using the camera on the capture device 50, takes multiple images of the item being digitized. Once the camera captures the multiple images, the multiple images are passed to a processing queue, where the application uses image processing capabilities to merge the multiple images captured by the camera into a single, high-resolution archival quality digital image. The multiple images captured by the camera may be passed to the processing queue in any digital image format; however, preferably the multiple images captured by the camera are passed to the processing queue in RAW format.

In addition to capturing images, the application may communicate with other capabilities within the capture device 50. For example, the application may utilize leveling capabilities of the capture device 50 to assist the user in leveling the capture device 50 prior to capturing images and the application may utilize a visual grid provided by software on the capture device 50, which is visible on a display of the capture device, to ensure the correct orientation between the capture device 50 and the item being digitized.

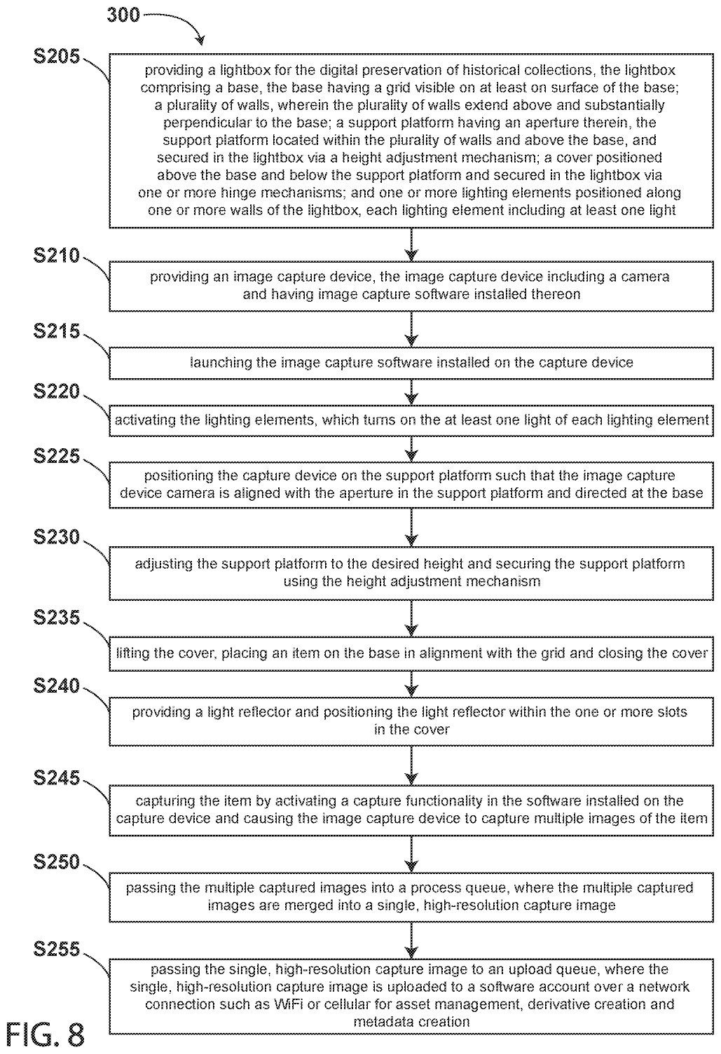

Turning to FIG. 8, a method 300 of using a lightbox 100 for the digital preservation of historical collections, a first step S205 includes providing a lightbox for the digital preservation of historical collections, the lightbox comprising a base, the base having a grid visible on at least one surface of the base; a plurality of walls, wherein the plurality of walls extend above and substantially perpendicular to the base; a support platform having an aperture therein, the support platform located within the plurality of walls and above the base, and secured in the lightbox via a height adjustment mechanism; a cover positioned above the base and below the support platform and secured in the lightbox via one or more hinge mechanisms; and one or more lighting elements positioned along one or more walls of the lightbox, each lighting element including at least one light. A second step S210 includes providing an image capture device, the image capture device including a camera and having image capture software installed thereon. A third step S215 includes launching the image capture software installed on the capture device. A fourth step S220 which may be performed at any time prior to capturing the image of the item being digitized, includes activating the one or more lighting elements, which turns on the lights. A fifth step S225 includes positioning the capture device on the support platform such that the image capture device camera is aligned with the aperture in the support platform and directed at the base, while a sixth step S230 includes adjusting the support platform to the desired height and securing the support platform using the height adjustment mechanism. A seventh step S235 includes lifting the cover and placing an item on the base in alignment with the grid and closing the cover over the item. An eighth step S240 includes providing a light reflector and positioning the light reflector within the one or more slots in the cover of the lightbox. A ninth step S245 includes capturing the item by activating a capture functionality in the software installed on the capture device and causing the image capture device to capture multiple images of the item. A tenth step S250 comprises passing the multiple captured images into a process queue, where the multiple captured images are merged into a single, high-resolution capture image. An eleventh step S255 includes passing the single, high-resolution capture image to an upload queue, where the single, high-resolution capture image is uploaded to a software account over a network connection such as WiFi or cellular for asset management, derivative creation and metadata creation. While these steps have been recited in an order, a person of skill in the art will appreciate that the steps may be rearranged without deviating from the scope of the present invention.

The method 300 of using a lightbox 100 for the digital preservation of historical collections, may also include an optional step of aligning the visual grid with the grid 2 on the base 2 in embodiments where the capture device includes software that provides a visual grid. In addition, in embodiments where the capture device includes software that provides a visual grid, the method 300 may also include the optional step of aligning the visual grid with the edge of the item being digitized once the cover is closed.

It is noted that the foregoing examples have been provided merely for the purpose of explanation and are in no way to be construed as limiting of the present invention. While the present invention has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A lightbox for the digital preservation of historical collections, the lightbox comprising:
a. a base, the base having a grid visible on at least one surface of the base;
b. a plurality of walls, wherein the plurality of walls extend above and substantially perpendicular to the base;
c. a support platform having an aperture therein, the support platform located within the plurality of walls and above the base, and secured in the lightbox via a height adjustment mechanism;
d. a cover positioned above the base and below the support platform and secured in the lightbox via one or more hinge mechanisms; and
e. one or more lighting elements positioned along one or more walls of the lightbox, each lighting element including at least one light.

2. The lightbox of claim 1 wherein each of the one or more lighting elements include a lens.

3. The lightbox of claim 2 wherein the plurality of walls is three walls and the one or more lighting elements is three lighting elements, and each lighting element is positioned horizontally along one of the three walls at a height, and with the lens positioned at an angle, to ensure that the base receives even lighting.

4. The lightbox of claim 3 wherein the three lighting elements are each positioned approximately two inches above the base and the lens of each lighting element is positioned at an angle of approximately 25 degrees relative to the wall.

5. The lightbox of claim 4 wherein the lens is a Fresnel lens.

6. The lightbox of claim 1 further comprising an image capture device, the image capture device having a camera and having an image capture application installed thereon, the image capture device positioned on the support platform such that the camera is directed through the support platform aperture and toward the base.

7. The lightbox of claim 1 wherein each of the one or more lighting elements comprises one or more LEDs mounted to one or more aluminum bars.

8. The lightbox of claim 1 further comprising a light reflector, the light reflector removably secured to the cover by inserting the light reflector into one or more slots located near the front edge of the cover.

9. The lightbox of claim 6 wherein the cover includes a frame wherein the one or more slots in the cover are located within the frame and the light reflector is removably secured to the cover by inserting the light reflector into the one or more slots.

10. The lightbox of claim 2 wherein the one or more hinged mechanisms is a pair of floating hinge mechanisms and the cover includes a pair of protrusions and is removably engaged with the pair of floating hinge mechanisms via the pair of protrusions.

11. A method of using a lightbox for the digital preservation of historical collections, the method comprising:
a. providing a lightbox for the digital preservation of historical collections, the lightbox comprising:
i. a base, the base having a grid visible on at least one surface of the base;
ii. a plurality of walls, wherein the plurality of walls extend above and substantially perpendicular to the base;
iii. a support platform having an aperture therein, the support platform located within the plurality of walls and above the base, and secured in the lightbox via a height adjustment mechanism;
iv. a cover positioned above the base and below the support platform and secured in the lightbox via one or more hinge mechanisms; and
v. one or more lighting elements positioned along one or more walls of the lightbox, each lighting element including at least one light;
b. providing an image capture device, the image capture device including a camera and having image capture software installed thereon;
c. launching the image capture software installed on the capture device;
d. activating the one or more lighting elements, which turns on the at least one light of each lighting element;
e. positioning the capture device on the support platform such that the image capture device camera is aligned with the aperture in the support platform and directed at the base;
f. adjusting the support platform to the desired height and securing the support platform using the height adjustment mechanism;
g. lifting the cover and placing an item on the base in alignment with the grid and closing the cover over the item;
h. providing a light reflector and positioning the light reflector within the one or more slots in the cover of the lightbox;
i. capturing the item by activating a capture functionality in the software installed on the capture device and causing the image capture device to capture multiple images of the item;
j. passing the multiple captured images into a process queue, where the multiple captured images are merged into a single, high-resolution capture image; and
k. passing the single, high-resolution capture image to an upload queue, where the single, high-resolution capture image is uploaded to a software account over a network connection such as WiFi or cellular for asset management, derivative creation and metadata creation.

12. The method of claim 11 wherein the capture device further includes software that provides a visual grid, visible on a display of the capture device, and further comprising aligning the visual grid with the grid on the base.

13. The method of claim 11 wherein the capture device further includes software that provides a visual grid, visible on a display of the capture device, and further comprising aligning the visual grid with the edge of the item to ensure the correct orientation once the cover is closed.
